(19) United States
(12) Patent Application Publication
(10) Pub. No.: US 2010/0140043 A1
(43) Pub. Date: Jun. 10, 2010

(54) Drive Assembly For A Regenerative Drive System

(75) Inventors: John Graham Thompson, Victoria (AU); Christopher Scott Marshall, New South Wales (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Permo-Drive Technologies Ltd, South Lismore (AU)

(21) Appl. No.: 12/523,315

(22) PCT Filed: Jan. 10, 2008
(86) PCT No.: PCT/AU08/00021

§ 371 Date: Jan. 28, 2010

(30) Foreign Application Priority Data
Jan. 16, 2007 (AU) 2007900200

(51) Int. Cl. F16D 23/00

(52) U.S. Cl. 192/30 R

(57) ABSTRACT

A drive assembly (10) for a regenerative drive system (11) that incorporates a pump/motor (12) and an electronic and a hydraulic control system (13). When incorporated in a motor lorry, and the motor lorry is de-accelerating a second clutch part (20) of the assembly (10) is engaged with a first clutch part (19) to thereby drive the pump/motor (12). The pump/motor (12) is rendered inoperative by operation of a clutch (18).

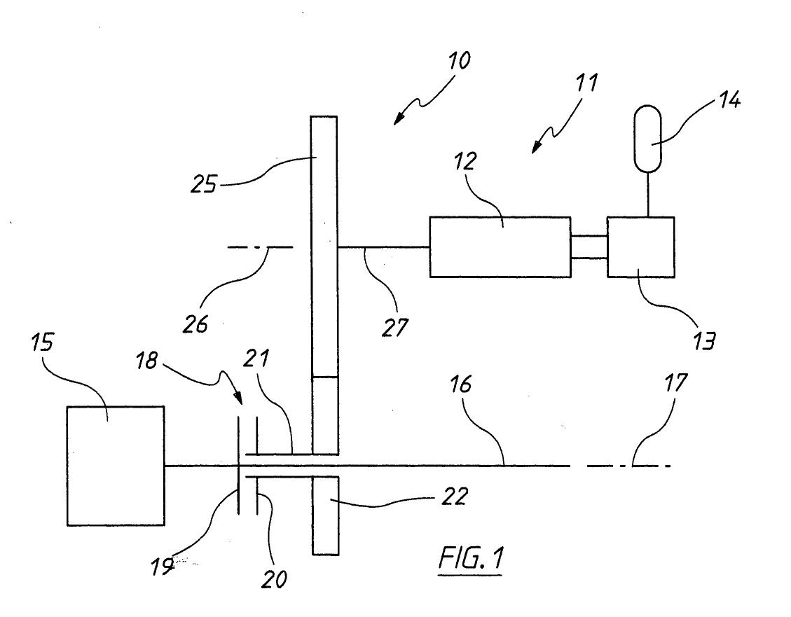

### TECHNICAL FIELD

The present invention relates to drive assemblies employing a clutch, and more particularly but not exclusively to drive assemblies for regenerative drive systems for motor vehicles such as motor lorries.

### BACKGROUND OF THE INVENTION

Described in International Patent Applications PCT/AU2005/001241, PCT/AU2006/001426, PCT/AU2003/001235, PCT/AU2003/001238, PCT/AU2003/001236, PCT/AU2003/001237, PCT/AU2003/000757, PCT/AU2003/001237, PCT/AU2003/00040, PCT/AU2003/00042 and PCT/AU2003/00041 are regenerative drive systems, including pumps/motors, electrical and hydraulic control systems, particularly adapted for motor lorries for the purposes of recovering energy that would be normally dissipated when a motor lorry is de-accelerating.

Regenerative drive systems typically are driven from a main drive shaft (such as a tail shaft) of the motor lorry. This includes the provision of a gear box that is displaced laterally relative to the drive shaft and which couples the drive shaft to the pump that is operated to charge a reservoir.

Although the object of these regenerative drive systems is to capture energy, they also lose energy due to the various gear mechanisms employed.

### OBJECT OF THE INVENTION

It is the object of the present invention to overcome or substantially ameliorate the above disadvantage.

### SUMMARY OF THE INVENTION

There is disclosed herein a drive assembly including:

a drive shaft having a longitudinal axis and that is rotatably driven about said axis;

a clutch surrounding the shaft and through which the clutch extends so as to provide a shaft portion beyond the clutch, the clutch having a first clutch part associated with the shaft so as to be rotated therewith, and a second clutch part selectively movable into engagement with the first clutch part so as to be drivingly associated therewith, and a drive member engaged with the second clutch part so as to be drivingly associated therewith so that the drive member and shaft portion can be simultaneously driven when the first and second clutch parts are engaged.

Preferably, said drive member is a first gear rotatable about said longitudinal axis, and said assembly includes a second gear meshingly engaged with the first gear and rotatable about a gear axis that is displaced laterally from said longitudinal axis.

There is further disclosed herein a regenerative drive system including the above drive assembly, and a pump connected to said second gear to be driven thereby and to drive said second gear.

Preferably, said gear axis is generally parallel but transversely spaced from said longitudinal axis.

### BRIEF DESCRIPTION OF THE DRAWING

A preferred form of the present invention will now be described by way of example with reference to the accompanying drawing that schematically depicts a drive assembly for a regenerative drive system.

### DETAILED DESCRIPTION OF THE PREFERRED EMBODIMENT

In the accompanying drawing there is schematically depicted a drive assembly 10 for a regenerative drive system 11 that incorporates a pump/motor 12 and an electronic and a hydraulic control system 13 that delivers hydraulic fluid under pressure to a reservoir 14. When the pump/motor 12 is being driven the reservoir 14 is charged with hydraulic fluid under pressure. However, the pump/motor 12 can also be driven by delivering hydraulic fluid under pressure from the reservoir 14 to the pump/motor 12 so that the pump/motor 12 can drive the drive assembly 10.

The drive assembly 10 is coupled to an engine, gear box and clutch assembly 15 of a motor lorry. Extending rearwardly from the assembly 15 is a drive shaft 16 that extends to a rear axel via which the motor lorry would be typically driven. The shaft 16 has a longitudinal axis 17. Accordingly the shaft 16 extends through the assembly 15 so as to have a portion 29 beyond the assembly 15.

Surrounding the shaft 16 is a clutch 18 having a first clutch part 19 fixed to or at least operatively associated with the shaft 16 so as to rotate therewith when the shaft 16 is driven about its longitudinal axis 17. The clutch 18 includes a second clutch part 20 that is selectively movable into engagement with the first clutch part 19 so as to be drivingly connected thereto. When spaced from the first clutch part 19, the clutch part 20 is relatively stationary.

Attached to or fixed to the second clutch part 20 is a sleeve 21 to which there is attached a first gear 22. The first gear 22 has as its longitudinal rotational axis the axis 17 and is rotated thereabout in unison with the first clutch part 20.

Meshingly engaged with the gear 22 is a second gear 25 having a rotational gear axis 26 that is generally parallel to but transversely spaced from the axis 17.

The gear 25 is connected via a shaft 27 to the pump/motor 12 of the regenerative drive system 11.

In operation of the above described drive assembly 10, when the motor lorry is de-accelerating the second clutch part 20 is engaged with the first clutch part 19 so that the gear 22 is driven together with the gear 25 and the pump/motor 12. The pump/motor 12 then charges the reservoir 14. When energy from the reservoir 14 is to be employed, the clutch parts 19 and 20 are again engaged and hydraulic fluid unde pressure delivered to the pump/motor 12 from the reservoir 14 so that the system 11 drives the shaft 16.

When the pump/motor 12 is not in operation, the clutch 18 is disengaged, that is the clutch part 19 and 20 are spaced so that the clutch part 20 is generally stationary. Accordingly the gears 22 and 25 as well as the pump/motor 12 are essentially inoperative, thereby saving the loss of energy.

Preferably, the assembly 15 includes a clutch that is disengaged when the clutch 18 is engaged to driving the pump/motor 12.

1. A drive assembly including:
a drive shaft having a longitudinal axis and that is rotatably driven about said axis;
a clutch surrounding the shaft and through which the clutch extends so as to provide a shaft portion beyond the clutch, the clutch having a first clutch part associated with the shaft so as to be rotated therewith, and a second clutch part selectively movable into engagement with the first clutch part so as to be drivingly associated therewith, and a drive member engaged with the second clutch part so as to be drivingly associated therewith so that the drive member and shaft portion can be simultaneously driven when the first and second clutch parts are engaged.

2. The drive assembly of claim 1, wherein said drive member is a first gear rotatable about said longitudinal axis, and said assembly includes a second gear meshingly engaged with the first gear and rotatable about a gear axis that is displaced laterally from said longitudinal axis.

3. In combination a regenerative drive system including the above drive assembly of claim 1, and a pump connected to said second gear to be driven thereby and to drive said second gear.

4. The drive assembly of claim 1, wherein said gear axis is generally parallel but transversely spaced from said longitudinal axis.

5. (canceled)
